(19) United States
(12) Patent Application Publication
(10) Pub. No.: US 2003/0021908 A1
(43) Pub. Date: Jan. 30, 2003

(54) Gas cluster ion beam process for smoothing MRAM cells

(76) Inventors: Janice H. Nickel, Sunnyvale, CA (US); Thomas C. Anthony, Sunnyvale, CA (US)

Correspondence Address: HEWLETT-PACKARD COMPANY, Intellectual Property Administration, P.O. Box 272400, Fort Collins, CO, 80527-2400, US

(21) Appl. No.: 09/917,509

(22) Filed: Jul. 27, 2001

(51) Int. Cl. B05D 1/36; B05D 5/12

(52) U.S. Cl. 427/551; 427/127; 427/402

(57) ABSTRACT

A method for fabricating a magnetoresistive memory cell with improved roughness uniformity and reduced roughness amplitude of a selected layer of material in the magnetoresistive memory cell by smoothing at an atomic scale an interface surface of the selected layer is disclosed. The smoothing is accomplished by irradiating an interface surface of the selected layer with a collimated beam of gas cluster ions that are accelerated along a beam bath by predetermined acceleration voltage. The gas cluster ions bombard the interface surface and upon impact therewith, the gas cluster ions disintegrate in a direction that is substantially lateral to the beam path. As a result, the gas cluster ions laterally sputter the interface surface and remove one or more monolayers of material from the interface surface. Consequently, an initial surface roughness of the interface surface is reduced and homogenized (i.e. made uniform) to a final surface roughness. By atomic scale smoothing of a data layer or a reference layer that precedes a non-magnetic spacer layer, Néel coupling between the data layer and the reference layer can be reduced and uniformity of tunneling resistance among memory cells in an array can be improved. Smoothing by gas cluster ion bombardment can be used to replace a planarization process or to repair defects caused by the planarization process. Deposition of the layers of the memory cell and gas cluster ion smoothing of a selected one of those layers can be done insitu to reduce or eliminate contamination or surface reactions.

### FIELD OF THE INVENTION

The present invention relates generally to a method of smoothing at an atomic scale one or more monolayers of material in a magnetoresistive memory to improve roughness uniformity and to reduce roughness amplitude of the layer. More specifically, the present invention relates to a method of gas-cluster ion-beam bombardment of one or more layers of material in a magnetoresistive memory to remove one or more monolayers of the material to improve roughness uniformity and to reduce roughness amplitude of the layer.

### BACKGROUND ART

A magnetic random access memory (MRAM) includes an array of memory cells formed from stacked layers of material (i.e. a sandwich of thin magnetic and non-magnetic materials). Of those layers, a bit of data is stored in a ferromagnetic data layer (also referred to as a sense layer, a free layer, or a storage layer) that is separated from a ferromagnetic reference layer (also called a pinned layer) by a thin spacer layer (also called a barrier layer).

In a giant-magneto-resistance (GMR) memory cell, the spacer layer is a thin layer of a non-magnetic electrically conductive material such as copper (Cu), for example. On the other hand, in a tunnel-magneto-resistance (TMR) memory cell, the spacer layer is a thin layer of a dielectric material such as aluminum oxide (Al₂O₃), or silicon oxide (SiO₂), aluminum nitride (AlN), and tantalum oxide (TaO).

In either case, the spacer layer may be only a few angstroms thick (i.e. less than about 3.0 nm thick). If an interface surface between the reference layer and the spacer layer or an interface surface between the data layer and the spacer layer is not substantially planar (i.e. flat), then a magnetostatic field can result from interface roughness. The interface roughness manifests itself as a variation in surface height. The interface roughness is commonly referred to as root mean square (RMS) surface roughness. Although other terminology can be used to describe interface roughness, RMS surface roughness is often used as an approximation of interface roughness. RMS surface roughness is particularly applicable in those instances were the interface roughness has an approximately sinusoidal variation in surface height (i.e. peaks or valleys having an amplitude h and a wavelength λ) or a or a sin² variation in surface height.

It is well known in the MRAM art that stray magnetic fields can affect the data layer of a memory cell where a bit of data is stored as an alterable orientation of magnetization. Two separate effects tend to produce those stray magnetic fields in the plane of the data layer. The first effect is referred to as a demagnetization field D as illustrated in FIGS. 1a through 1c. In FIG. 1a, a prior magnetic memory cell 100 includes a data layer 110, a reference layer 112, and a non-magnetic spacer layer 114. Because the data layer 110 and the reference layer 112 are made from ferromagnetic materials that are positioned in close proximity to each other, a pinned orientation of magnetization M1 of the reference layer 112 generates a demagnetization field D that extends from an edge of the reference layer 112 to the data layer 110, as illustrated in FIG. 1b. The demagnetization field D can be parallel to M2 as illustrated in FIG. 1c or the demagnetization field D can be anti-parallel to M2 as illustrated in FIG. 1d.

FIGS. 1c and 1d illustrate the effect of the demagnetization field D on an alterable orientation of magnetization M2 (dashed arrow) of the data layer 110. Ideally, the orientation of magnetization M2 of the data layer 110 would have an alignment that is either parallel or anti-parallel to the pinned orientation of magnetization M1 (a parallel orientation is shown). The demagnetization field D results in a shifting of a response loop from symmetry about a zero field point (i.e. H=0) as illustrated in FIG. 8a. It is desirable to have the response loop centered at zero field so that it is easier to detect the state of the bit stored in the data layer 110 and the currents required to switch the bit one way or the other are approximately equal. However, due to the demagnetization field D, the response loop is left shifted in a negative direction of the H axis as illustrated in FIG. 8b. The departure from perfect symmetry about the H=0 axis due to the demagnetization field D is denoted as ΔH_{D}.

The second effect is referred to as Néel “orange peel” coupling (also referred to as interlayer magnetic coupling). Néel coupling arises due to interface roughness at an interface between the spacer layer and the data layer and/or the spacer layer and the reference layer. Néel coupling adversely impacts the performance, reliability, and yield of prior magnetic memory cells in the following ways.

First, Néel coupling causes the aforementioned response curve to be right shifted in a positive direction of the H axis as illustrated in FIG. 8c. The departure from perfect symmetry about the H axis due to Néel coupling is denoted as ΔH_{N}. Often, the field due to Néel coupling predominates over the field due to the demagnetization field D so that when both fields are present the response curve is still right shifted. The demagnetization field D can be substantially eliminated by using a structure in the memory stack such as a synthetic antiferromagnet (SAF), for example. In contrast, the field due to Néel coupling can be reduced by reducing or eliminating the interface surface roughness.

Second, the interface surface roughness can have a surface topology that includes variations in surface height (e.g. peaks and valleys) that are not sufficiently covered by the spacer layer. As a result, the data layer and the reference layer may contact each other and cause an electrical short in TMR memory cells. Because the state of a bit stored in the data layer is typically sensed by measuring a resistance across the data layer and the reference layer, an electrical short effectively renders the memory cell inoperative.

Third, the variations in surface height result in variations in distance between opposed surfaces of the data layer and the reference layer. A tunneling resistance R of the memory cell is dominated by the shortest distance between the data layer and the reference layer. Accordingly, for an array of the memory cells with variations in height across the array, there will be wide variation in tunneling resistance R among the memory cells in the array. Consequently, there will be non-uniformity in tunneling resistance. It is desirable to have the tunneling resistance R be uniform throughout the array so that a tunneling resistance R indicative of a logic “0” or a logic “1” falls within a predictable range.

Therefore, Néel coupling between the data layer and the reference layer is one technological hurdle that must be minimized or eliminated in order to produce MRAM devices with a yield and a reliability that will make those devices a commercially viable alternative to other data storage devices.

FIGS. 2 through 5 illustrate prior examples of memory cells that are made from stacked layers of materials that can include, non-magnetic spacer layers, ferromagnetic layers, pinning layers, pinned layers, buffer layers, cap layers, seed layers, and a substrate layer, just to name a few.

In FIG. 2, a prior memory cell 200 includes two ferromagnetic layers FM1 and FM2 that are separated by a thin spacer layer. For purposes of simplifying the illustration, the other layers of the prior memory cell 200 as described above are not shown. Depending on the order in which the layers of the prior memory cell 200 are deposited, the layer FM1 can be a reference layer and the layer FM2 can be a data layer, or vice-versa. Nevertheless, regardless of the deposition order, an interface surface I_{S} will be formed between the Spacer and the layers (FM1, FM2) as shown by the dashed circle. Although the interface surface I_{S} appears to be planar in the profile view of FIG. 2, a closer inspection with an instrument such as a transmission electron microscope (TEM) for a cross-sectional view or an atomic force microscope (AFM) for a plan view, reveals that the interface surface I_{S} is not planar and has an initial surface roughness as a result of the processes used to form the layers (FM1, FM2, Spacer).

FIGS. 6a through 6c illustrate prior fabrication steps for forming the FM2 layer, the Spacer layer, and the FM1 layer in a deposition order D_{O}. In FIG. 6a, the FM2 layer is deposited on a layer that preceded it (not shown) in the deposition order D_{O}, The interface surface I_{S} (i.e. the surface upon which a subsequent layer will be deposited in the deposition order D_{O}) is not planar and has an initial surface roughness S_{Rl} that includes portions having peaks P and valleys V. In FIG. 6b, the next layer to be deposited in the deposition order D_{O} is the Spacer. Because of the initial surface roughness S_{Rl} in the FM2 layer that preceded the Spacer in the deposition order D_{O}, the Spacer also has an initial surface roughness S_{Rl} (possibly different and not necessarily conformal) with peaks P and valleys V. In FIG. 6c, the next layer in the deposition order D_{O} is the FM1 layer that conformally covers the Spacer resulting in an initial surface roughness S_{Rl} for the FM1 layer as well.

FIG. 7a demonstrates the effect that the initial surface roughness S_{Rl} of the FM2 layer has on Néel coupling between the FM2 and FM1 layers through the Spacer layer. Because of the initial surface roughness S_{Rl} of the FM2 layer, free magnetic poles N and S are induced on the surfaces of the FM2 and FM1 layers along the interface surface I_{S}. For purposes of illustration, assuming that the interface surface I_{S} has a surface roughness that can be approximated by a sinusoidal roughness profile, then a magnetic field H_{N} due to the Néel coupling can be calculated by the following equation (1):

H_{N}=π²/√2(h²λT_{F})M_{S}exp(−2π*/√2T_{S}/λ) (1)

Where λ is the wavelength and h is the amplitude of the initial surface roughness S_{Rl}, T_{F} and T_{S} are the thickness of the free layer (FM1) and the Spacer layer respectively, and Ms is the magnetization of the free layer (FM1). The Néel coupling is proportional to the RMS surface roughness of the layers (FM1, FM2). Typically, the actual surface roughness of the interface surface I_{S} is not approximately sinusoidal; however, the magnetic field H_{N} due to the Néel coupling will be present whenever there is surface roughness regardless of the shape of the roughness profile.

One of the disadvantages of Néel coupling due to the initial surface roughness S_{Rl} is illustrated in FIGS. 8a and 8c. Ideally, a magnetic memory cell would have a hysteresis loop (i.e. a response curve) that is symmetric about a M and a H axis of FIG. 8a. However, due to Néel coupling, the hysteresis loop is right-shifted as illustrated in FIG. 8c.

FIG. 7b depicts two bits on an MRAM array and illustrates another disadvantage of the initial surface roughness S_{Rl}. Because of the initial surface roughness S_{Rl}, the Spacer has a non-uniform thickness. Consequently, a distance D₁ from the peaks P is closer to the interface surface I_{S} of the FM1 layer than a distance D₂ from the valleys V. Because the peaks P are closer (i.e. D₁<D₂), a tunneling resistance R_{T1} is less than a tunneling resistance R_{T2}. Because the tunneling resistance is exponentially dependent on the distance D between the FM1 and FM2 layers, the effect D has on tunneling resistance is large. Consequently, the tunneling resistance is dominated by R_{T1} due to the reduced distance D, of the peaks P to the interface surface I_{S} of the FM2 layer. Therefore, in an array of memory cells, the tunneling resistance will vary among the cells in the array due to variations in the initial surface roughness S_{Rl} among the cells. As a result, the tunneling resistance is non-uniform throughout the memory array. For instance, in FIG. 7b, D₁<D₃ therefore R_{T1}<R_{T3}. Uniformity of the tunneling resistance throughout the memory array is important because the tunneling resistance is sensed to determine the state of the bit of data in the data layer. If the tunneling resistance is not uniform, then it may be very difficult or nearly impossible to accurately determine a logic “0” from a logic “1”.

Prior attempts to reduce or eliminate the initial surface roughness S_{Rl} and to improve surface uniformity include depositing a thicker spacer layer, single atom ion beam milling, layer planarization such as chemical mechanical planarization (CMP), and deposition process control.

In FIG. 9, the thickness T_{S} of the Spacer is increased with the expectation that the Néel coupling field will be exponentially reduced according to equation (1) above. In addition, increasing the thickness of the Spacer may partially planarize the initial surface roughness S_{Rl} of the FM2 layer and result in a smoother interface surface I_{S} at the FM1 layer. However, increasing the thickness T_{S} results in another initial surface roughness S_{Rl} at the interface surface I_{S} of the FM1 layer. In some instances, a thicker layer can increase the initial surface roughness S_{Rl} of a subsequent layer. Furthermore, in those applications where a thin Spacer layer is required, increasing the thickness of the Spacer is not a suitable option because the resulting device would not be useful due to the exponential increase in tunneling resistance caused by the thicker spacer layer.

In FIG. 10a, the FM1 layer has been planarized by a process such as CMP to form a substantially planar and smooth interface surface I_{S} along a plane 101. However, CMP can introduce defects in the interface surface I_{S}. For instance, those defects include a particle 103 from compounds and slurries that are used in the CMP process and can become embedded in the interface surface I_{S}, asperities 105 that are abrupt features that extend outward of the interface surface I_{S}, and scratches 107 that are a result of damage to the interface surface I_{S} by the CMP process. Furthermore, in order to perform CMP or the like on the interface surface I_{S}, vacuum must be broken in a deposition chamber used to deposit the layer to be planarized. Breaking vacuum can result in contamination of the interface surface I_{S} and/or degradation of the surface via a chemical reaction with the atmosphere such as oxidation of the interface surface I_{S}.

FIG. 10b illustrates the adverse effects of the defects of the planarization process depicted in FIG. 10a. First, because the Spacer layer is typically very thin, the particle 103 may not be completely covered by the Spacer and cause an electrical short 102 between the FM1 layer and the FM2 layer. The asperities 105 can punch through the thin Spacer (see reference numeral 104) and cause an electrical short, or the asperities 105 can create a new initial surface roughness 106 in the FM2 layer. The scratch 107 can create a crevasse that the Spacer can not conformally fill. When the FM2 layer is deposited over the crevasse, a void 108 in the Spacer can cause an electrical short between the FM1 and FM2 layers.

Single atom ion beam milling is moderately effective at removing some material from the interface surface I_{S}. However, it is not necessarily how much material is removed but rather the resulting surface morphology that determines ΔH_{N}. Accordingly, Néel coupling is not significantly reduced by single atom ion milling because only moderate changes to the surface morphology of the interface surface I_{S} can be had using single atom ion milling.

Similarly, controlling a microstructure of a surface by deposition process control requires that a growth rate and a thickness of an underlayer such as the FM1 layer, be precisely controlled during the deposition process. However, the use of deposition process control cannot prevent the formation of initial surface roughness S_{Rl} and therefore is not an effective means for substantially reducing initial surface roughness S_{Rl}. Furthermore, deposition process control increases manufacturing costs and decreases throughput time.

FIGS. 3 through 5 illustrate prior magnetic memory cells formed from stacked layers of material. Although the prior discussion has focused on the interface surface I_{S} between the Spacer layer and the data and reference layers (FM1, FM2), the problems associated with initial surface roughness S_{Rl} can also exist between other layers in the memory stack. Consequently, an interface surface I between selected layers in the memory stack can have an initial surface roughness S_{Rl} that can be propagated up through the stack and can lead to defects that reduce yield or reliability of the memory cell.

In FIG. 3, a prior tunneling magnetoresistance (TMR) memory cell 300 includes an NiFe/Ta seed layer, an antiferromagnetic (AF) pinning layer of IrMn, PtMn, or MnFe, a NiFe pinned reference layer, a thin Al₂O₃ tunnel barrier layer (Spacer), a NiFe data layer, a Ta cap layer, and a silicon (Si) substrate. Any of those layers, particularly those that proceed the Spacer in a deposition order D_{O} can have an interface surface I that includes an initial surface roughness S_{Rl} that can either add to or cause the initial surface roughness S_{Rl} in a layer that immediately precedes the Spacer or can create the initial surface roughness S_{Rl} in subsequent layers. For instance, in FIG. 3 the interface surface I between the seed layer and the AF pinning layer or the interface surface I between the layers within the seed layer can have the initial surface roughness S_{Rl}.

In FIG. 4, an even more complicated stack of materials are used to form a prior tunneling magnetoresistance (TMR) memory cell 400. The initial surface roughness S_{Rl} can exist at any selected layer in the stack. For example, the initial surface roughness S_{Rl} can be between the Ru/CoFe layers, the Ru/Ta layers, the lrMn, PtMn/Ru layers as indicated by the interface surface I, or the initial surface roughness S_{Rl} can be between the CoFe/Al₂O₃ layers as illustrated by the interface surface I_{S}. The initial surface roughness S_{Rl} of the above layers can be due to lattice mismatch dislocations cause by strain relaxation.

In FIG. 5, a prior giant magnetoresistance (GMR) memory cell 500 includes a non-magnetic Cu Spacer and a Ta buffer layer on top of a silicon (Si) substrate. If the initial surface roughness S_{Rl} is at the interface surface I between the Ta buffer layer and the NiFe data layer, then the interface surface I_{S} between the NiFe/Cu layer may also have an initial surface roughness=S_{Rl-NiFe}+S_{Rl} from the Ta layer that preceded it in the deposition order D_{O} (i.e. often the effects of initial surface roughness are exaggerated with thickness).

The effects of the initial surface roughness S_{Rl} on the interface surface I are further illustrated in the cross-sectional views of FIGS. 11 and 12. In FIG. 11, a layer 131 of a memory stack has an initial surface roughness S_{Rl} at an interface surface I. Subsequently, another layer 133 of the memory stack is deposited on the layer 131 and the layer 133 also has an initial surface roughness S_{Rl} that is due in part to the initial surface roughness S_{Rl} of the preceding layer 131. The initial surface roughness S_{Rl} of layer 133 can propagate into a layer 135 that is subsequently deposited on the layer 133. Therefore, the initial surface roughness S_{Rl} of the layer 131 can negatively effect the surface topology (i.e. roughness amplitude and roughness uniformity of the subsequent layer is made worse) of one or more layers that are deposited after the layer 131 in a deposition order D_{O}. Those subsequent layers can include the non-magnetic spacer layer, the data layer, or the reference layer.

Similarly, in FIG. 12, a layer 115 includes an initial surface roughness at an interface surface I caused by surface defects including a particle 123, asperities 125, and a scratch 127. Those surface defects contribute to an initial surface roughness at an interface surface I of a subsequent layer 117 that is deposited on the layer 115 in a deposition order D_{O}. As was mentioned previously, those surface defects can be caused by a planarization process such as CMP or the like. Later deposited layers such as a layer 119 can be affected by the initial surface roughness of the layers 115 and 117.

The initial surface roughness in the layers illustrated in FIGS. 11 and 12 can cause defects in one or more layers of a memory cell such as the Seed layer, the Pinning layer, or the SAF Pinned Reference layers of FIG. 4, the AF Pinning layer of FIG. 3, or the Data layer of FIG. 5.

Therefore, there is a need for a process for improving roughness uniformity and for reducing roughness amplitude of one or more layers in a magnetic memory cell. Additionally, there exists a need to smooth an interface surface of one or more layers in a memory cell to reduce Néel coupling and to improve tunneling resistance uniformity. There is also a need to smooth an interface surface of one or more layers in a memory cell without having to break vacuum in order to perform the smoothing of a layer. Finally, there exists a need to improve roughness uniformity and to reduce roughness amplitude at an interface surface of a spacer layer of a magnetic memory cell.

### SUMMARY OF THE INVENTION

The present invention solves the aforementioned problems by smoothing at an atomic scale one or more selected layers of material in a magnetic memory cell. The selected layer can be a layer that precedes a non-magnetic spacer layer, a layer that immediately precedes the non-magnetic spacer layer, or it can be one or more layers within a stack of layers in the magnetic memory cell including a layer that is deposited after the non-magnetic spacer layer.

Broadly, the present invention is embodied in a method for smoothing at an atomic scale a selected layer of material in a magnetic memory cell by bombarding an interface surface of the selected layer with a collimated beam of gas cluster ions. Upon impact with the interface surface, the gas cluster ions penetrate the interface surface and disintegrate in a direction that is substantially lateral to a beam path of the gas cluster ions thereby laterally sputtering the interface surface. The impact displaces one or more monolayers of material from the interface surface such that an initial surface roughness of the interface surface is reduced and homogenized (i.e. has a uniformity of roughness) to a final surface roughness. As a result, a roughness amplitude of the interface surface is reduced and a roughness uniformity of the interface surface is improved.

The aforementioned problems associated with Néel coupling and non-uniformity of tunneling resistance are addressed by the present invention. Néel coupling is reduced by smoothing the interface surface at an atomic scale to reduce variation in surface height of an interface surface of a layer that precedes the non-magnetic spacer layer in a deposition order. Furthermore, by smoothing the interface surface, variations in distance between the data layer and the reference layer of the memory cell are reduced resulting in an increased uniformity of tunneling resistance among memory cells in an array of memory cells.

One advantage of the present invention is that the aforementioned surface defects caused by planarization processes such as CMP and the like can be repaired by bombarding the interface surface with gas cluster ions. The gas cluster ions can dislodge or abrade particle defects and can smooth out surface irregularities such as asperities, scratches, and the like. Moreover, because the method of the present invention smooths out a layer of material, planarization of the layer can be accomplished using gas cluster ion bombardment instead of the prior planarization processes. Accordingly, the particle defects, the asperities, and the surface scratches attributed to the prior planarization processes such as CMP can be eliminated. Moreover, smoothing of a layer can be accomplished without having to break vacuum thereby reducing or eliminating surface reactions and contamination.

Another advantage of the present invention is that the surface roughness in any layer of a memory cell can be reduced to provide a smooth interface surface upon which to deposit a subsequent layer of the memory cell. By smoothing the interface surface the initial surface roughness of subsequently deposited layers can be reduced.

In one embodiment of the present invention, the selected layer is a layer that precedes the non-magnetic spacer layer in the deposition order.

In an alternative embodiment of the present invention, several layers are selected for smoothing at an atomic scale using gas cluster ion bombardment.

In one embodiment of the present invention, all layers are selected for smoothing at an atomic scale using gas cluster ion bombardment.

In another embodiment of the present invention, the selected layer is a layer that immediately precedes the non-magnetic spacer layer in the deposition order.

In yet another embodiment of the present invention, the selected layer that immediately precedes the non-magnetic spacer layer in the deposition order is a data layer or a reference layer.

In one embodiment of the present invention, the selected layer is the non-magnetic spacer layer.

In alternative embodiments of the present invention, the selected layer includes a ferromagnetic layer, a pinned layer, a pinning layer, a seed layer, a cap layer, a buffer layer, a current carrying layer, or a layer of an antiferromagnetic.

In another embodiment of the present invention the antiferromagnetic is an artificial antiferromagnet, a synthetic antiferromagnet, or a synthetic ferrimagnet.

In one embodiment of the present invention, a layer of material is deposited insitu in a deposition chamber and if that layer is selected to be smoothed at an atomic scale, then the layer is smoothed insitu in a smoothing chamber using gas cluster ion bombardment.

In yet another embodiment of the present invention, the deposition chamber and the smoothing chamber are interconnected. In another embodiment, the deposition chamber and the smoothing chamber are a single integrated unit.

Other aspects and advantages of the present invention will become apparent from the following detailed description, taken in conjunction with the accompanying drawings, illustrating by way of example the principles of the present invention.

### BRIEF DESCRIPTION OF THE DRAWINGS

FIG. 1a is a cross-sectional view of a prior magnetic memory cell.

FIG. 1b is a cross-sectional view of the prior magnetic memory cell of FIG. 1a and illustrating a demagnetization field extending from an edge region thereof.

FIGS. 1c and 1d are plan views illustrating an additive and subtractive effect respectively of the demagnetization field on the alterable orientation of magnetization of a data layer.

FIG. 2 is a plan view of a prior memory cell including two ferromagnetic layers separated by a spacer layer.

FIG. 3 is a plan view of illustrating one type of prior tunneling magnetoresistance memory cell made from stacked layers of material.

FIG. 4 is a plan view of illustrating another type of prior tunneling magnetoresistance memory cell made from a more complicated stack of materials.

FIG. 5 is a plan view of illustrating one type of prior giant magnetoresistance memory cell made from stacked layers of material.

FIGS. 6a through 6c are an illustration of fabrications steps for forming the prior memory cell of FIG. 2 in a deposition order and a representation of the resulting interface roughness.

FIG. 7a is a cross-sectional view of the prior memory cell of FIG. 2 illustrating the effect of interface roughness on Néel coupling between the ferromagnetic layers through the spacer layer.

FIG. 7b is a cross-sectional view of two bits in a prior MRAM array word line of FIG. 2 illustrating the effect of non-uniform spacer thickness on tunneling resistance.

FIGS. 8a through 8c are plots illustrating an ideal symmetric response curve, a left-shifted response curve due to a demagnetization field, and a right-shifted response curve due to Néel coupling respectively.

FIG. 9 is a cross-sectional view of a prior magnetic memory cell in which a thickness of a spacer layer has been increased in an attempt to reduce surface roughness at an interface surface with a ferromagnetic layer.

FIG. 10a is a cross-sectional view of a prior magnetic memory cell in which an interface surface of a ferromagnetic layer has surface irregularities resulting from a planarization process.

FIG. 10b is a cross-sectional view of defects resulting from deposition of subsequent layers on the interface surface of FIG. 10a.

FIGS. 11 and 12 are cross-sectional views of an initial surface roughness of an interface surface a prior memory cell and the effects of the initial surface roughness on subsequently deposited layers.

FIGS. 13a through 13d are cross-sectional views of a method for smoothing at an atomic scale one or more monolayers of material from an interface surface of a selected layer of material in a magnetic memory according to the present invention.

FIGS. 14a through 14c are cross-sectional views of a method for smoothing at an atomic scale one or more monolayers of material from an interface surface having an RMS surface roughness according to the present invention.

FIG. 15 is a cross-sectional view of an apparatus for smoothing at an atomic scale one or more monolayers of material from an interface surface of a selected layer of material in a magnetic memory using gas cluster ion bombardment according to the present invention.

FIG. 16 is a cross-sectional view of an apparatus for insitu deposition of a selected layer of material in a magnetic memory and insitu smoothing at an atomic scale one or more monolayers of material from an interface surface of the selected layer of material using gas cluster ion bombardment according to the present invention.

FIG. 17 is a cross-sectional view of a magnetic memory cell comprising stacked layers of material deposited in a deposition order according to the present invention.

FIGS. 18a through 18d are cross-sectional views of a method for smoothing at an atomic scale an interface surface of a selected layer of material from the stack of FIG. 17 using gas cluster ion bombardment according to the present invention.

FIG. 19 is a cross-sectional view of a reference layer having an approximately sinusoidal surface topology that has been smoothed by gas cluster ion bombardment to reduce Néel coupling according to the present invention.

FIG. 20 is a plot illustrating response curves due to Néel coupling before and after atomic scale surface smoothing according to the present invention.

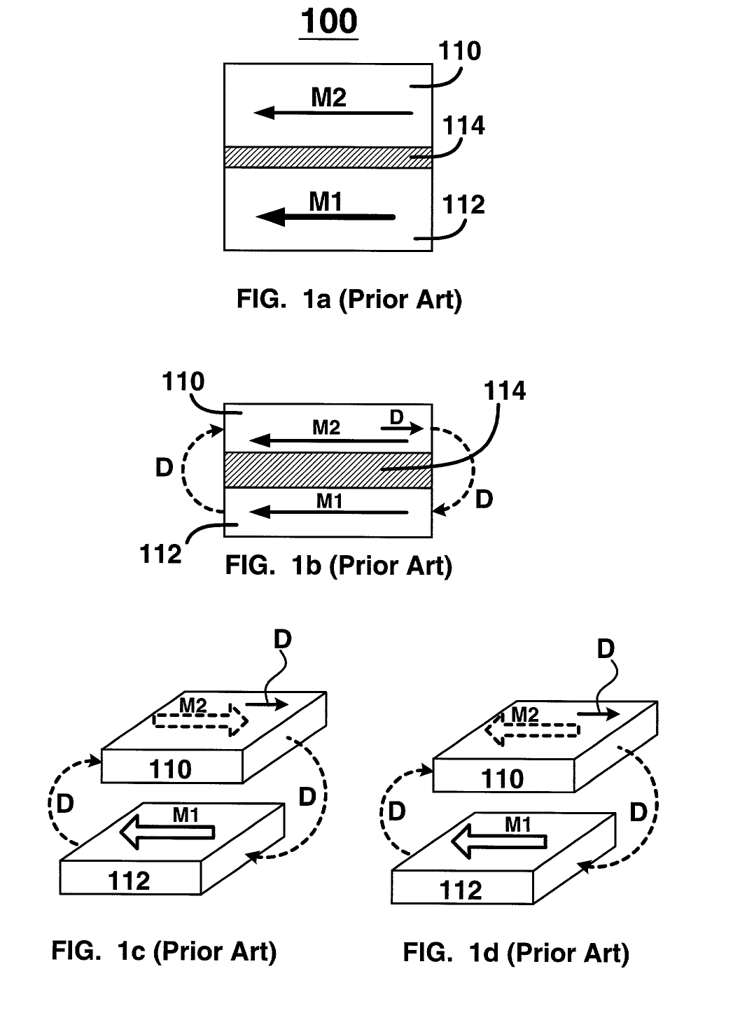

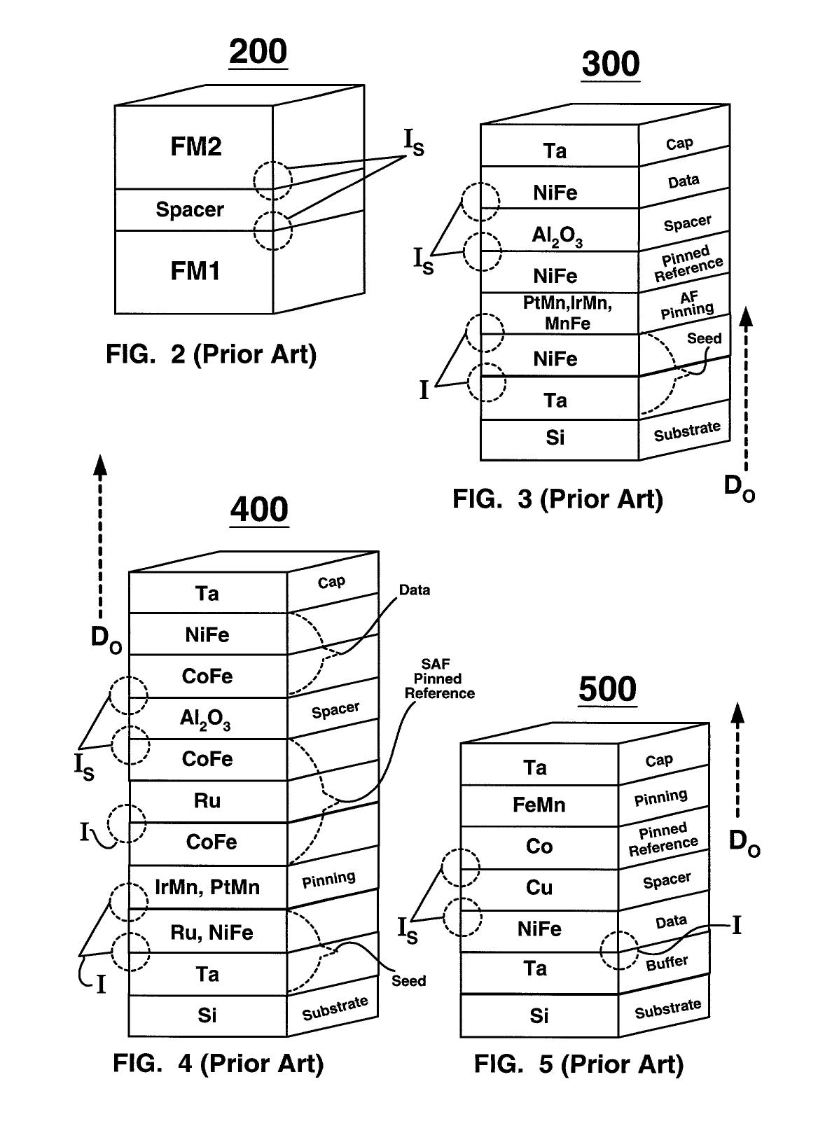

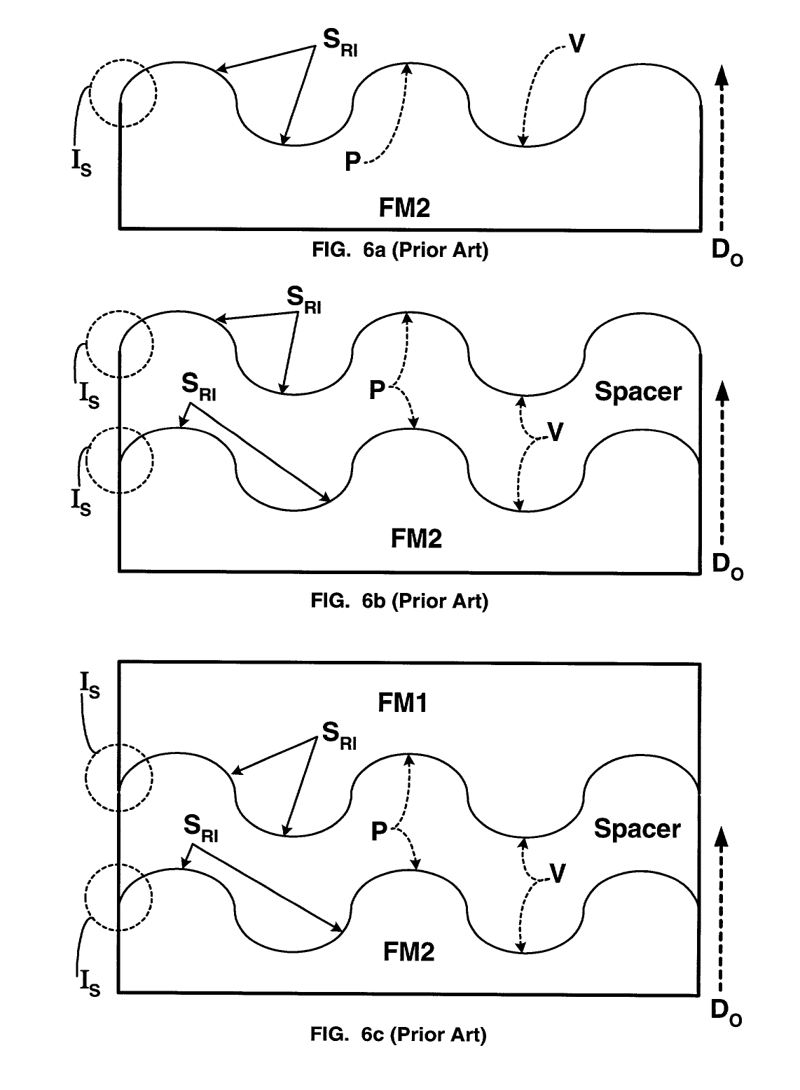

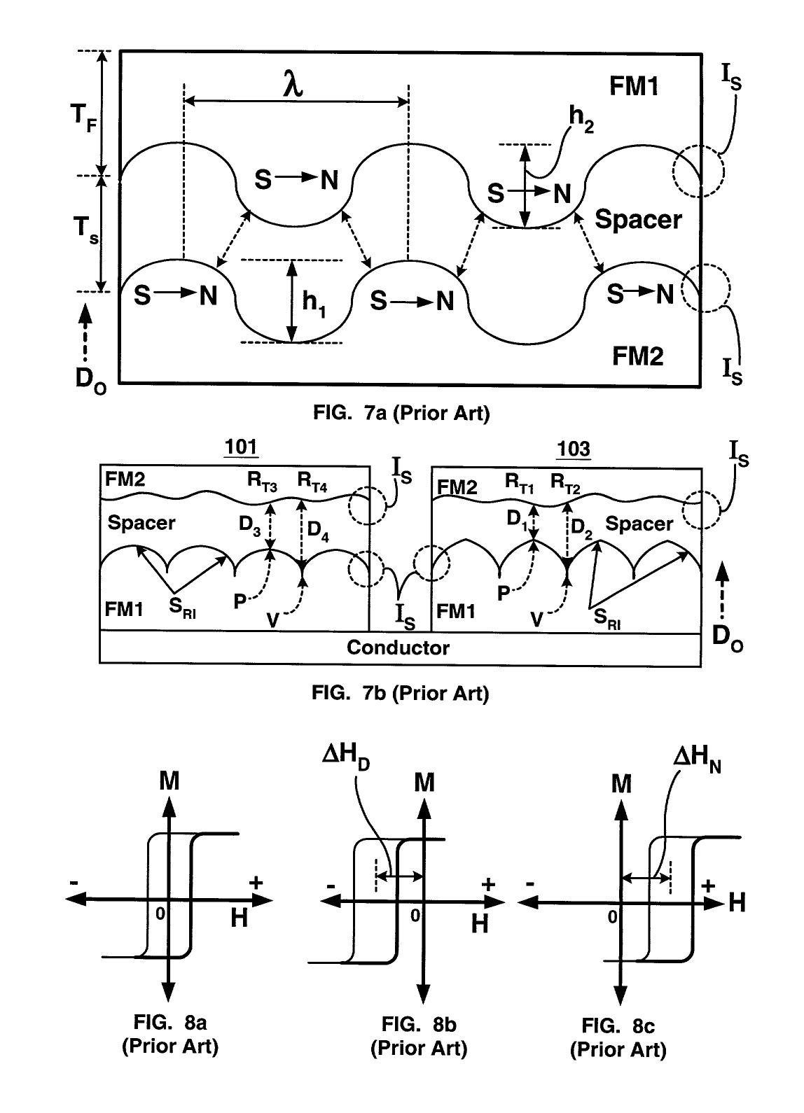

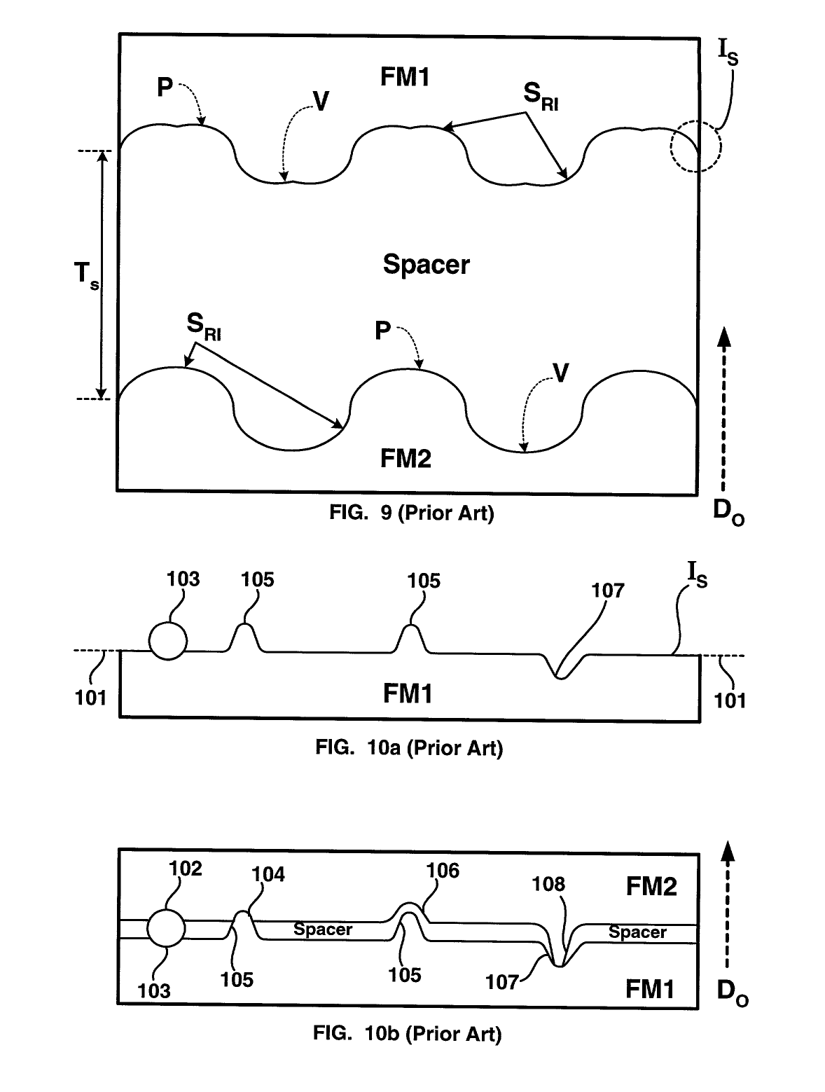

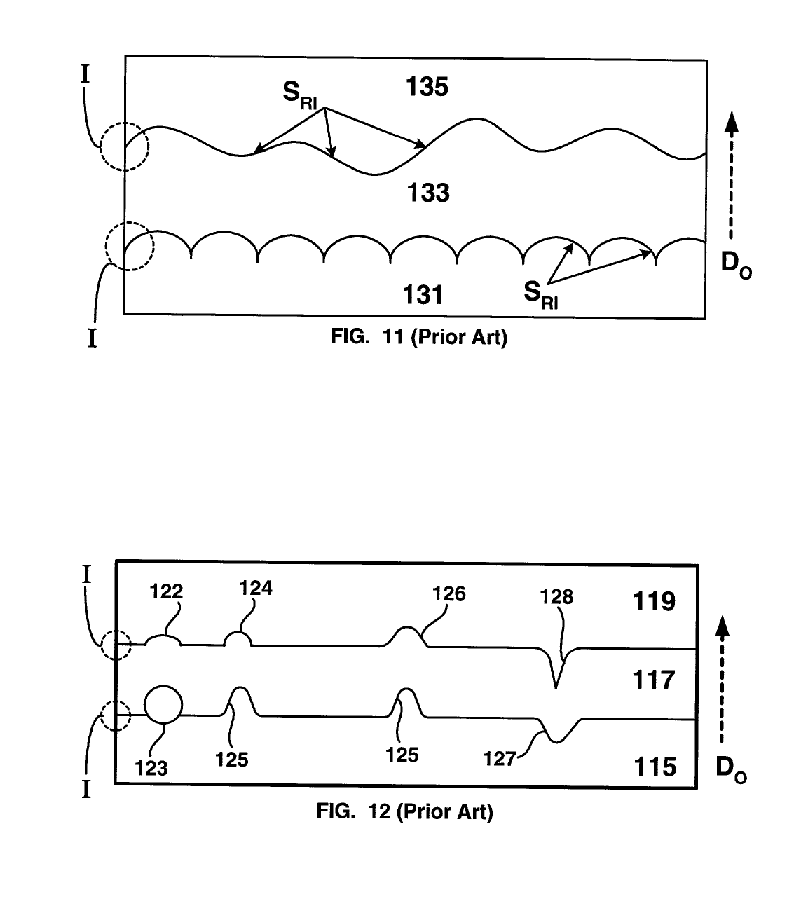

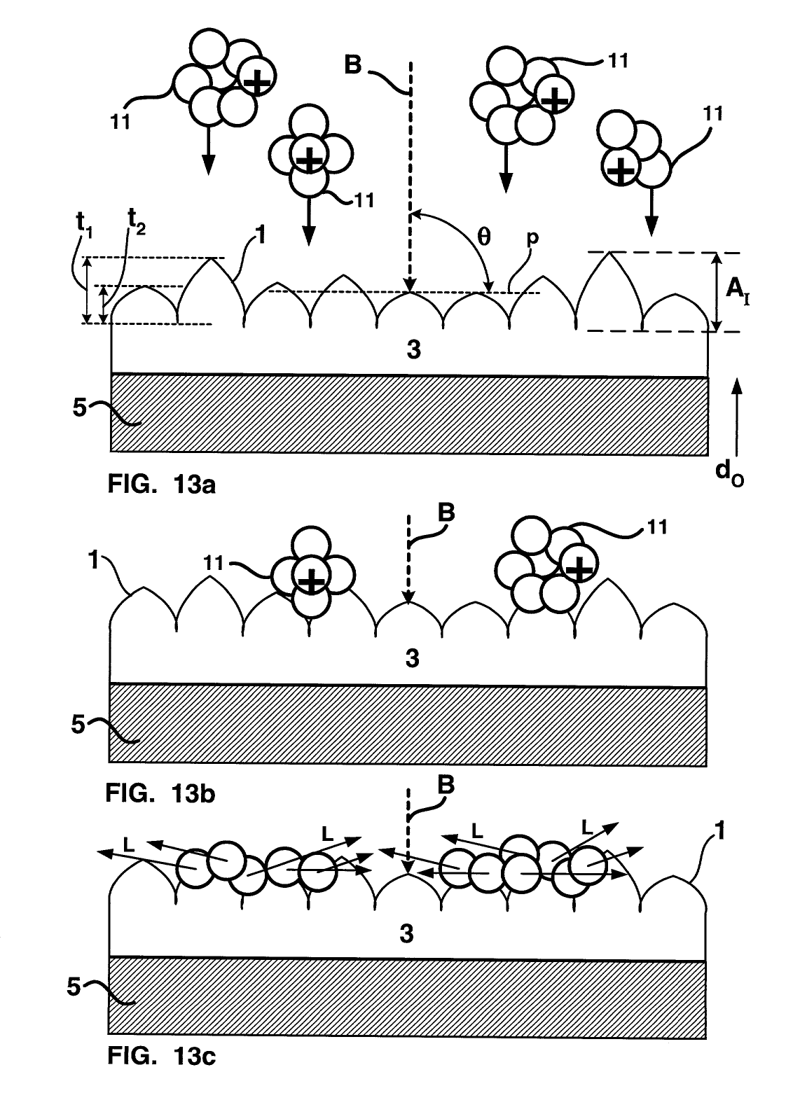

### DETAILED DESCRIPTION

In the following detailed description and in the several figures of the drawings, like elements are identified with like reference numerals.

As shown in the drawings for purpose of illustration, the present invention is embodied in a method for fabricating a magnetoresistive memory cell with improved roughness uniformity and reduced roughness amplitude of a selected layer of material in the magnetoresistive memory cell by smoothing at an atomic scale an interface surface of the selected layer. The smoothing is accomplished by irradiating the interface surface with a collimated beam of gas cluster ions that are accelerated along a beam bath by predetermined acceleration voltage. The gas cluster ions bombard the interface surface and upon impact with the interface surface, the gas cluster ions disintegrate in a direction that is substantially lateral to the beam path. As a result, the gas cluster ions laterally sputter the interface surface and remove one or more monolayers of material from the interface surface. Consequently, an initial surface roughness of the interface surface is reduced and homogenized (i.e. is made uniform) to a final surface roughness.

One mechanism that causes the initial surface roughness includes any layer in the memory cell that has an interface surface with barrier roughness initiated by lattice mismatch dislocations due to strain relaxation. Those dislocations initiate grain boundaries, which grow into dome like structures. The thicker the layers past the dislocations, the rougher the interface surface is.

The method according to the present invention can be used to smooth at an atomic scale any selected layer of material in a magnetoresistive memory cell or any selected number of layers in a magnetoresistive memory cell. The selected layer can be any layer that precedes a non-magnetic spacer layer in a deposition order including a layer that immediately precedes the non-magnetic spacer layer in the deposition order. Additionally, the non-magnetic spacer layer or any layer deposited after the non-magnetic spacer layer can be smoothed at an atomic scale using the method of the present invention.

Benefits of reducing the initial surface roughness include reduced Néel coupling between a data layer and a reference layer of the magnetoresistive memory cell. Néel coupling is reduced by making the interface surface upon which the non-magnetic spacer layer will be deposited as smooth as possible using gas cluster ion bombardment. Uniformity of tunneling resistance among memory cells in an array of memory cells is another benefit of atomic scale surface smoothing according to the present invention. By smoothing the interface surface upon which the non-magnetic spacer layer is deposited, variations in distance between the data layer and the reference layer of the memory cell are reduced resulting in an increased uniformity of tunneling resistance among memory cells in an array of memory cells.

One advantage of the present invention is that the aforementioned surface defects caused by the prior planarization processes such as CMP and the like can be repaired by bombarding the interface surface with gas cluster ions. Moreover, the method of the present invention can be used to planarize the interface surface of the selected layer thereby eliminating the need for the aforementioned prior planarization processes. Accordingly, the particle defects, the asperities, and the surface scratches attributed to the prior planarization processes such as CMP are mooted by the method of the present invention.

Another advantage of the present invention is that a surface roughness in any layer of a memory cell can be reduced to provide a smooth interface surface upon which to deposit a subsequent layer of the memory cell. By smoothing the interface surface the initial surface roughness of the subsequently deposited layers can be reduced.

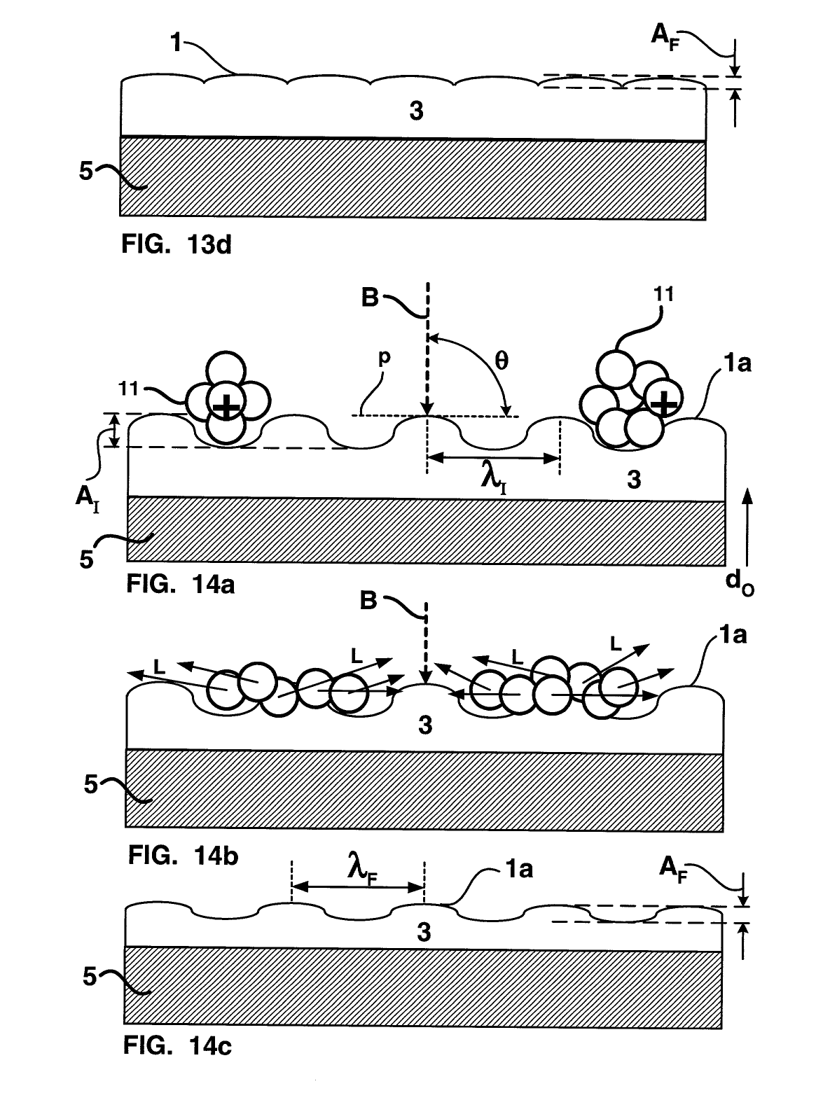

In FIG. 13a, a method of fabricating a magnetoresistive memory cell that includes a plurality of stacked layers is illustrated. For purposes of illustration only two layers are shown in FIG. 13a; however, it is clearly understood in the MRAM art that a magnetoresistive memory cell typically includes a plurality of layers made from a variety of materials. In FIG. 13a, a selected layer 3 is deposited on a precursor layer 5 in a deposition order do. Therefore, the precursor layer 5 was deposited before the selected layer 3 in the deposition order do. Other layers (not shown) may have been deposited before the precursor layer 5 in the deposition order d_{O}. An interface surface 1 of the selected layer 3 includes an initial surface roughness A_{I}. Essentially, the initial surface roughness A_{I}, is a measure of an amplitude of surface roughness of the interface surface 1 and includes non-uniform surface roughness that manifest itself as variations in surface height as illustrated by t₁ and t₂ (see FIG. 13a, where: t₁>t₂).

In FIG. 13a, A_{I} is illustrated as a maximum amplitude of surface roughness; however, other measures of A_{I} can be used. For instance, A_{I} can be the average surface roughness or an RMS surface roughness as will be discussed below. The initial surface roughness A_{I} can be caused by a process used to deposit the selected layer 3, by surface roughness in the precursor layer 5, or a combination of both. The interface surface 1 is smoothed at an atomic scale by irradiating the interface surface 1 with a collimated beam of gas cluster ions 11. Each gas cluster ion 11 includes a plurality of discrete atoms or particles. The gas cluster ions 11 are accelerated along a beam path B by a predetermined acceleration voltage as will be described below.

In FIG. 13b, the gas cluster ions 11 impact the interface surface 1 and in FIG. 13c, upon impact with the interface surface 1, the gas cluster ions 11 penetrate the interface surface and disintegrate in a direction that is substantially lateral to the beam path B as indicted by arrows L in FIG. 13c. The lateral motion L of the discrete atoms of the gas cluster ions 11 has the effect of laterally sputtering the interface surface 1 so that one or more monolayers of the material from which the selected layer 3 is made are removed by the lateral sputtering. The number of monolayers removed will depend in part on the material of the selected layer 3, the thickness of a monolayer, the composition of the gas cluster ions 11, and the acceleration voltage. For instance, for aluminum oxide (Al₂O₃), 12 monolayers≈5.0 nm≈50.0 Å. As a result of the lateral sputtering, the initial surface roughness A_{I} is reduced and homogenized to a final surface roughness A_{F} as illustrated in FIG. 13d. The final surface roughness A_{F} is homogenized because the non-uniformity of surface roughness t₁ and t₂ from FIG. 13a are made uniform by the gas cluster ion bombardment. The initial surface roughness A_{I} is reduced because the final surface roughness A_{F} has a roughness amplitude that is less than the initial surface roughness A_{I} (A_{F}<A_{I}). One advantage of the lateral surface sputtering is that it has a smoothing, cleaning, and planarization effect on the interface surface 1.

In FIG. 14a, the above mentioned process of atomic scale smoothing is applied to an interface surface la that includes initial surface roughness A_{I} having an approximately sinusoidal surface topology with an initial surface roughness A_{I}. The sinusoidal surface topology is for illustration purposes only and the actual surface morphology of the interface surface will vary depending on several factors including the material deposited and the deposition process, just to name a few. The initial surface roughness A_{I} is a distance between peaks and valleys of the interface surface 1a; whereas, a wavelength λ_{I} is a distance between adjacent peaks or between adjacent valleys. The interface surface 1a is bombarded with gas cluster ions 11 as was described above. In FIG. 14b, the gas cluster ions 11 impact and laterally sputter the interface surface 1a so that the initial surface roughness A_{I} is reduced and homogenized to a final surface roughness A_{F} as illustrated in FIG. 14c.

The apparatus and process for forming gas cluster ions is well understood in the microelectronics art. Basically, gas cluster ions are formed by a gas under high pressure that expands at a high velocity from a nozzle and then condenses in a chamber under vacuum. Random thermal energy in the gas is converted into directed kinetic energy of a high velocity gas cluster flow. Each gas cluster is composed of discrete atoms or molecules that are held together by weak inter-atomic forces called van der Waals forces. Each gas cluster can contain only a few atoms or it can contain several thousands of atoms. A collimated beam is produced by a skimmer having a small aperture therein for passing a core of the expanding high velocity gas cluster flow from the nozzle. The collimated beam passes through an ionization section where low energy electrons are injected into the gas flow to impart a monovalent charge to one of the atoms in the cluster thereby ionizing the cluster. The ionized cluster has the charge of a single ion but has the mass of several to several thousands of atoms. Typically, the cluster is ionized with a positive charge. Once ionized, the collimated beam of gas cluster ions can be accelerated by an electric field in an acceleration section and optionally the beam can be steered by a deflection section comprising an electrostatic lens or the like to deflect the beam. The collimated beam follows a trajectory that is along a beam path.

The collimated beam of gas cluster ions has a high total energy, a large mass and a high momentum due to the combined mass of the constituent atoms of the cluster, but a low energy per constituent atom. Therefore, upon impact with a surface irradiated by the collimated beam of gas cluster ions, the gas cluster ions produces surface processing effects that are distinguishable from those of monomer ions. First, the gas cluster ions deliver all of their energy to the immediate surface without channeling effects. Secondly, unlike monomer ions, upon impact with a surface, the gas cluster ions bombard and possibly penetrate the surface with a large number of spatially coincident atoms that disintegrate upon impact in a direction that is substantially lateral to the beam path thereby laterally sputtering the surface at a high rate. The lateral sputtering can be used to smooth, clean, and planarize the surface.

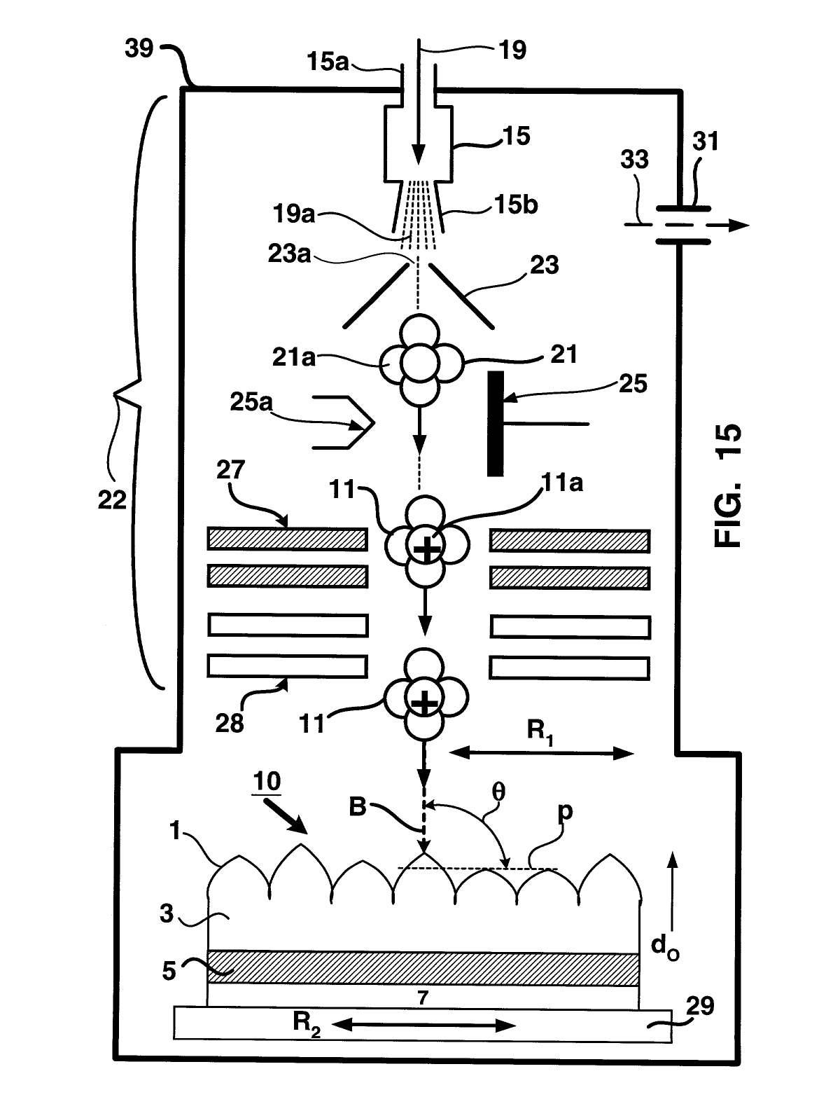

For illustration purposes, and not indicative of actual scale, the formation of a collimated beam of gas cluster ions is depicted in FIG. 15. In FIG. 15, an apparatus 22 for generating a collimated beam of gas cluster ions includes a housing 39 with a gas chamber 15. The gas chamber 15 includes a gas inlet 15a through which a gas 19 is introduced under high pressure and an expansion nozzle 15b. The housing 39 also includes at least one vacuum port 31 through which the housing 39 is evacuated by removing an atmosphere 33 from the housing 39 so that the housing 39 is kept at a pressure less than about 1×10⁻⁴ Torr. The gas 19 expands 19a at a high velocity as it exits the nozzle 15b to form cluster particles 21 that are composed of individual atoms 21a. A skimmer 23 having a small aperture 23a therein passes a core of the expanding gas 19a to produce a collimated beam of the cluster particles 21. The cluster particles 21 are ionized by passing the cluster particles 21 through an ionizer 25 that imparts a monovalent charge + to each of the gas cluster particles 21 to form gas cluster ions 11. As a result, a single atom or particle 11a in each gas cluster ion 11 has the monovalent charge +. For example, the ionizer 25 can generate thermoelectrons from a filament 25a and the cluster particles 21 are ionized as they pass through the thermoelectrons. An acceleration section 27 accelerates the gas cluster ions 11 by a predetermined acceleration voltage. The gas cluster ions 11 pass through a deflection section 28 for steering a beam path B of the gas cluster ions 11. For instance, the deflection section 28 can be an electrostatic lens. Optionally, the apparatus 22 can include a mass separation section (not shown) for producing a homogenous gas cluster ion beam. The mass separation section selectively passes gas cluster ions 11 having a predetermined mass.

The gas cluster ions 11 are accelerated along the beam path B and impact on an interface surface 1 of a selected layer 3 of a magnetoresistance memory cell 10. Upon impact, the gas cluster ions 11 laterally sputter the interface surface 1 as was described above in reference to FIGS. 13c and 14b. Although FIG. 15 illustrates the magnetoresistance memory cell 10 with three layers that have been formed in the deposition order d_{O}, the magnetoresistance memory cell 10 can include additional layers. The magnetoresistance memory cell 10 can be mounted to a chuck 29 or other similar device for securing the magnetoresistance memory cell 10 during the gas cluster ion bombardment process. For instance, a layer 7 can be a semiconductor substrate such as a single crystal silicon wafer.

In order to bombard an entirety of the interface surface 1 with the gas cluster ions 11, the beam path B can be moved R₁ relative to the interface surface 1 by the aforementioned deflection section 28, the chuck 29 can be moved R₂ relative to the beam path B, or a combination of moving the beam path B and the chuck 29 relative to each other (R₁ and R₂). For example, R₁ and R₂ can be a raster scan motion.

For all of the embodiments to be described herein, the interface surface 1 and the beam path B may be spatially oriented relative to each other so that the beam path B intersects the interface surface 1 at a substantially normal angle of incidence (i.e. substantially 90 degrees) as illustrated by an angle of incidence θ between the beam path B and a line p as illustrated in FIGS. 13a, 14a, and 15. For purposes of illustration, the line p is a line that is parallel to an ideally flat interface surface 1. On the other hand, the interface surface 1 and the beam path B may be spatially oriented relative to each other so that the beam path B does not intersect the interface surface 1 at a normal angle of incidence. That is, the angle of incidence θ between the beam path B and the line p can be varied so that the beam path B is not perpendicular to the line p and does not intersect the interface surface at a substantially normal angle of incidence.

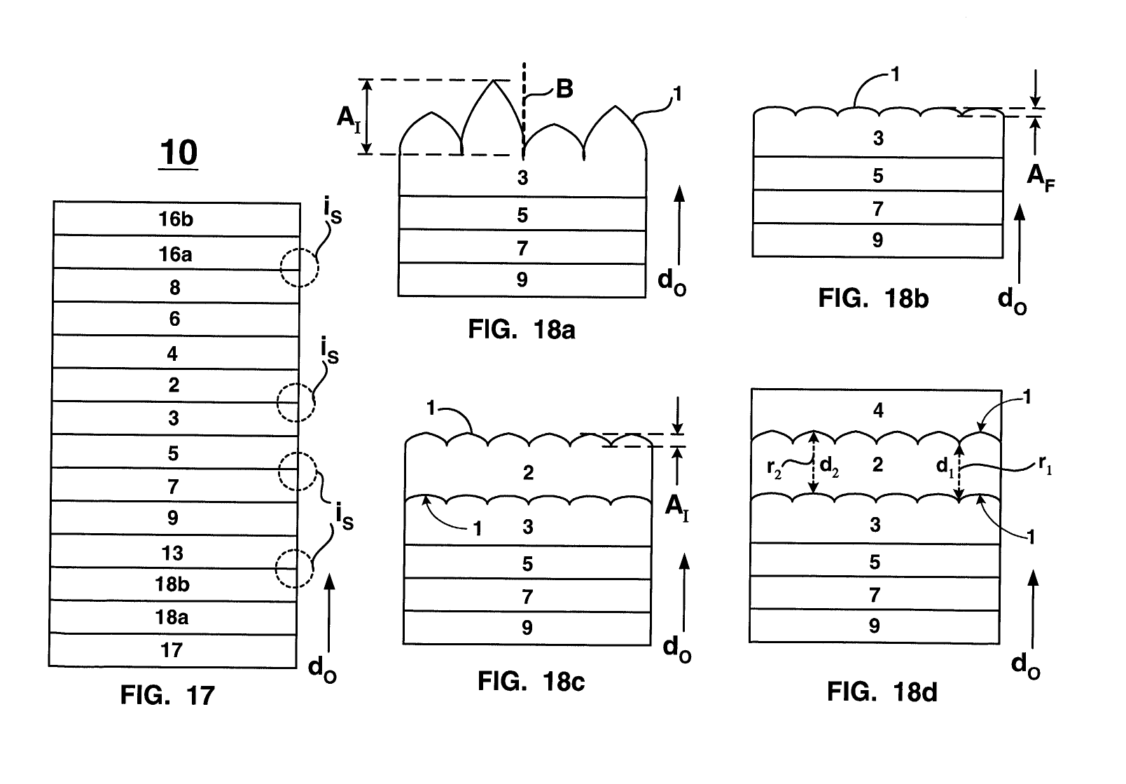

In FIG. 17 and in FIGS. 18a through 18d, one embodiment of a method of fabricating a magnetoresistive memory cell with improved roughness uniformity and reduced roughness amplitude is illustrated. FIGS. 18a through 18d illustrate a portion of the stacked layers of material illustrated in FIG. 17. A magnetoresistive memory cell 10 includes a plurality of stacked layers (fourteen are shown) that are deposited on a substrate layer 17 in a deposition order d_{O}. The stacked layers include a data layer 4 and a reference layer 3 that are separated by a non-magnetic spacer layer 2. For example, the memory cell 10 can be a TMR memory cell with the following layers deposited in the deposition order do starting at the substrate layer 17: Si/Ta/Cu/NiFe/Co/Ru/Co/NiFe/Al₂O₃/NiFe/Co/Ru/Cu or Co/Ta. On the other hand, memory cell 10 can be a GMR memory cell constructed from the appropriate materials for the layers and can have more layers or fewer layers than shown.

Between each layer in the stack there exists an interface i_{S} between adjacent layers in the stack that is not perfectly flat (i.e. it is not planar) due to a deposition process used to form a layer in the stack and/or due to initial surface roughness in a preceding layer. Regardless of the cause, it may be desirable or necessary to reduce surface roughness by smoothing at an atomic scale an interface surface of a layer in the stack prior to depositing the next layer in the stack.

In FIG. 17, the interface i_{S} between the reference layer 3 and the non-magnetic spacer layer 2 has been selected to be smoothed at an atomic scale using gas cluster ion bombardment as described herein. Accordingly, as illustrated in FIG. 18a, prior to depositing the non-magnetic spacer layer 2, an interface surface 1 of the reference layer 3 is selected for smoothing at an atomic scale. The interface surface 1 is irradiated with a collimated beam comprising a plurality of gas cluster ions 11 (see FIGS. 13a to 13d). The gas cluster ions 11 are accelerated along a beam path B by a predetermined acceleration voltage. The gas cluster ions bombard the interface surface 1 and disintegrate upon impact with the interface surface 1 in a direction that is substantially lateral L to the beam path B. The lateral motion of discrete atoms or particles of the gas cluster ions 11 have the effect of laterally sputtering the interface surface 1 so that an initial surface roughness A_{I} of the interface surface 1 is reduced and homogenized to a final surface roughness A_{F} as illustrated in FIG. 18b. The initial surface roughness A_{I} is homogenized because variations in the roughness amplitude are made substantially uniform by the gas cluster ion bombardment (see interface surface 1 of FIG. 18b) and the initial surface roughness A_{I} is reduced because the final surface roughness A_{F} is less than the initial surface roughness A_{I} (i.e. A_{F}<A_{I}). Consequently, the interface surface 1 of the atomically smoothed reference layer 3 has an improved roughness uniformity and a reduced roughness amplitude as illustrated in FIG. 18b.

The next layer in the deposition order d_{O} can now be deposited on the smoothed interface surface 1 of the preceding layer. In FIG. 18c, the next layer in the deposition order d_{O} is the non-magnetic spacer layer 2 and the preceding layer was the reference layer 3. After the deposition, the non-magnetic spacer layer 2 has an interface surface 1 that has an initial surface roughness A_{I}. However, because of the atomic scale smoothing of the interface surface 1 of the reference layer 3, the non-magnetic spacer layer 2 is deposited on a surface having the aforementioned roughness uniformity and reduced roughness amplitude. As a result, the initial surface roughness A_{I} of the interface surface 1 of the non-magnetic spacer layer 2 is less than it would have been if the interface surface 1 of the reference layer 3 had not been smoothed prior to depositing the non-magnetic spacer layer 2.

After the non-magnetic spacer layer 2 has been deposited, the next layer in the stack, the data layer 4, can be deposited on the interface surface 1 of the non-magnetic spacer layer 2 as illustrated in FIG. 18d. After depositing the data layer 4, the remaining layers as illustrated in FIG. 17 can subsequently be deposited. For example, if the data layer 4 is a NiFe layer, then layer 6 can be a Co layer, layer 8 can be a Ru layer, layer 16a can be a Cu or a Co layer, and layer 16b can be a Ta cap layer.

One benefit of atomic scale smoothing according to the present invention is that Néel coupling between the reference layer 3 and the data layer 4 is reduced by making the interface surface (1 or 1a) upon which the non-magnetic spacer layer 2 is deposited as smooth as possible using gas cluster ion bombardment.

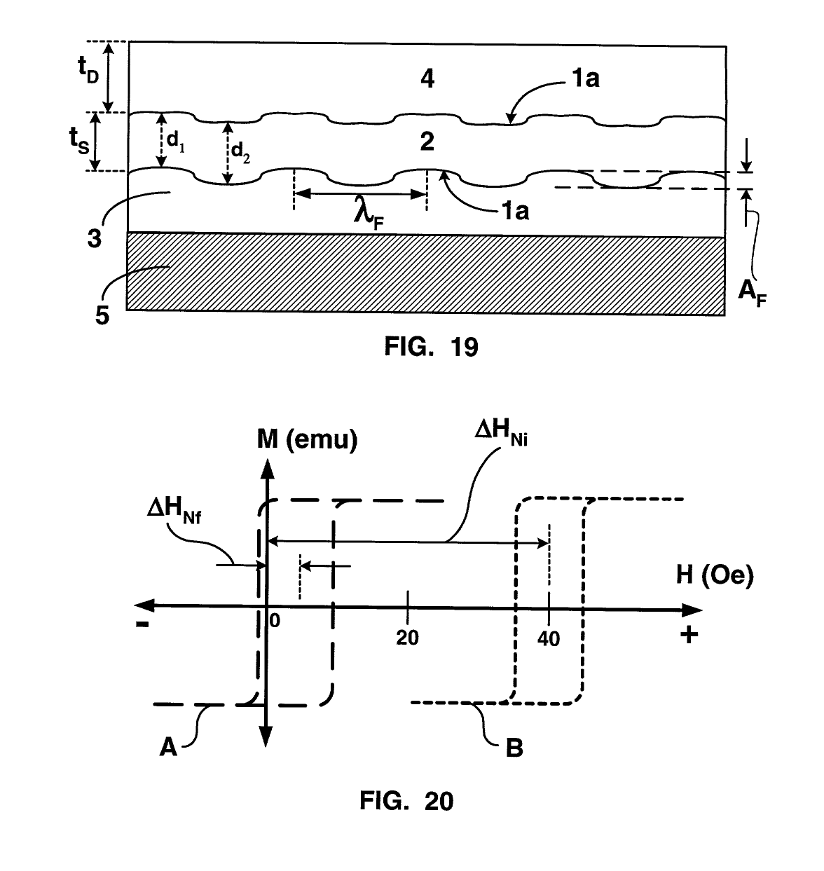

In FIG. 19, an interface surface 1a has a surface roughness that has an approximately sinusoidal roughness profile (see FIGS. 14a through 14c). A magnetic field H_{N} due to Néel coupling between the reference layer 3 and the data layer 4 after the interface surface 1a has been smoothed at an atomic scale can be calculated by the following equation (A):

H_{N}=π²/√2(A_{F}²/λ_{F}t_{D})M_{S}exp(−2π*√2t_{S}/λ_{F}) (A)

Where the wavelength λ_{F} is the distance between adjacent peaks or between adjacent valleys after smoothing by gas cluster ion bombardment, A_{F} is the amplitude of the final surface roughness, t_{D} and t_{S} are the thickness of the data layer 4 and the non-magnetic spacer layer 2 respectively, and M_{S} is the magnetization of data layer 4. The Néel coupling is proportional to the RMS surface roughness of the reference layer 3 and the data layer 4.

Néel coupling can also be measured by depositing the entire magnetic stack in a continuous sheet film and measuring magnetization M as a function of applied field H. The data layer 4 will have a coercivity centered at some value of the field: H=H_{N}.

As was mentioned previously, Néel coupling cause the response curve to be right-shifted away from a zero field point (H=0) such that the response curve is not symmetric about the M axis. In FIG. 20, before atomic scale smoothing using gas cluster ion bombardment, a response curve A is right-shifted and is centered at a field value on the order of about 40 Oersted, for example. The shift from perfect symmetry is indicated by ΔH_{Ni} which is the initial field due to Néel coupling (i.e. the Néel coupling field before atomic scale smoothing). After atomic scale smoothing using gas cluster ion bombardment according to the present invention, a response curve A illustrates a shift back towards perfect symmetry (i.e. H=0) and the shift from perfect symmetry is indicated by ΔH_{Nf} which is final field due to Néel coupling (i.e. the Néel coupling field after atomic scale smoothing such that: ΔH_{Ni}<ΔH_{Ni}) The response curve A is centered at a field value of about 5 Oersted. However, ΔH_{Ni} will depend on many factors including but not limited to the materials used for the layers in the stack and the thickness of those layers. For example, without gas cluster ion bombardment, ΔH_{Ni} could be between about 20 Oe to about 60 Oe, and with gas cluster ion bombardment, ΔH_{Nf} could be between about 1 Oe to about 10 Oe.

Regardless of the surface topology of the interface surface (1 or 1a), Néel coupling is reduced by the gas cluster ion bombardment method of the present invention because the roughness amplitude of the interface surface is reduced and homogenized as described above. Therefore, the reduction in Néel coupling does not depend on the interface surface having an approximately sinusoidal roughness profile.

Another benefit of atomic scale smoothing of the interface surface 1 of the reference layer 3 is that the non-magnetic spacer layer 2 has a substantially uniform thickness that minimizes differences in distance between the interface surface 1 of the reference layer 3 and the interface surface 1 of the data layer 4 thereby improving uniformity of tunneling resistance. In FIG. 18d, a distance d, between the interface surfaces of the reference and data layers (3, 4) is less than a distance d₂ between the interface surfaces of the reference and data layers (3, 4). A tunneling resistance r₁ is proportional to the distance d₁ and a tunneling resistance r₂ is proportional to the distance d₂. By atomic scale smoothing the interface surface 1 of the reference layer 3, the differences between r₁ and r₂ are minimized and wide variations in tunneling resistance among memory cells 10 in an array of memory cells are reduced.

The interface surface (1, 1a) can have a surface topology that includes but is not limited to those illustrated in FIGS. 13a, and 14a. In one embodiment of the present invention the initial surface roughness A_{I} is in a range from about 5 angstroms to about 40 angstroms and the final surface roughness A_{F} is in a range from about 1 angstrom to about 10 angstroms. In another embodiment of the present invention the initial surface roughness A_{I} is a first RMS surface roughness in a range from about 5 angstroms to about 40 angstroms and the final surface roughness A_{F} is a second RMS surface roughness in a range from about 1 angstrom to about 10 angstroms.

Measurement of the initial surface roughness A_{I} and the final surface roughness A_{F} can be accomplished using atomic force microscopy (AFM) for profile images of the selected layer. Alternatively, transmission electron microscopy (TEM) can be used to image a cross-sectional view of the selected layer. For instance, if surface roughness is in measured as a RMS surface roughness, then the initial surface roughness A_{I} can be a measured peak-to-valley distance after the selected layer has been deposited (i.e. as deposited) and the final surface roughness A_{F} can be a measured peak-to-valley distance after bombardment with the gas cluster ions 11.

Although the previous discussion has focused on smoothing at an atomic scale the interface surface 1 of the reference layer 3, the method of the present invention can be used to smooth at an atomic scale an interface surface of any selected layer of the magnetoresistive memory cell 10 or more than one layer of the magnetoresistive memory cell 10. The selected layer can be any layer that precedes the non-magnetic spacer layer 2 in the deposition order d_{O} including a layer that immediately precedes the non-magnetic spacer layer 2 in the deposition order d_{O}. Therefore, an interface surface 1 of a data layer or a reference layer could be smoothed at an atomic scale prior to depositing the non-magnetic spacer layer 2.

In one embodiment of the present invention, the selected layer is the substrate layer 17. Typically, the substrate layer 17 is a semiconductor substrate such as single crystal silicon (Si), a silicon wafer after the substrate or wafer has been thermally oxidized, or a silicon wafer coated with Si₃N₄. An interface surface of the substrate layer 17 can be smoothed at an atomic scale prior to depositing a subsequent layer such as a seed layer, a buffer layer, or a conductive layer including a current carrying layer.

In another embodiment of the present invention, the selected layer can be any layer of a magnetoresistance memory cell including but not limited to a ferromagnetic layer, a pinned layer, a pinning layer, a seed layer, a cap layer, a conductive layer including a current carrying layer, a substrate layer (e.g. the substrate layer 17), and a buffer layer. Additionally, the selected layer can be one or more layers of an antiferromagnet. The antiferromagnet can be an artificial antiferromagnet, a synthetic antiferromagnet, or a synthetic ferrimagnet.

The current carrying layer can be an electrically conductive layer including the word and bit lines that are used to write and/or read data to/from the memory cell by generating magnetic fields induced by currents flowing in the current carrying layer. The current carrying layer can be a material including but not limited to copper (Cu), aluminum (Al), tungsten (W), gold (Au), or composites like a ferromagnetic cladded conductor.

In one embodiment of the present invention, the selected layer is the non-magnetic spacer layer 2. The non-magnetic spacer layer 2 can be made from a thin layer of dielectric material such as aluminum oxide (Al₂O₃) or silicon oxide (SiO₂) for a TMR memory cell. On the other hand, the non-magnetic spacer layer 2 can be made from a non-magnetic electrically conductive material such as copper (Cu) for a GMR memory cell.

If the interface surface 1 of the non-magnetic spacer layer 2 is to be smoothed at an atomic scale using the gas cluster ion bombardment method of the present invention, caution should be taken to ensure the bombardment will not damage the non-magnetic spacer layer 2. Because the non-magnetic spacer layer 2 can be a very thin layer of material that is on the order of a few angstroms thick (e.g. about 6 Å or less), it is important that the mass of the gas cluster ions 11, the acceleration voltage, and the gas used to form the clusters be carefully selected so that the bombardment laterally sputters the interface surface 1 without damaging the non-magnetic spacer layer 2 or a layer that preceded the non-magnetic spacer layer 2 in the deposition order d_{O}.

The gas used to form the gas cluster ions 11 can include but is not limited to an inert gas such as argon (Ar), krypton (Kr), xenon (Xe), and helium (He). On the other hand, the gas used to form the gas cluster ions 11 can include but is not limited to a reactive gas such as nitrogen (N), hydrogen (H), oxygen (O). For instance, gas cluster ions 11 comprising oxygen (O) can be used to smooth a layer of aluminum oxide (Al₂O₃). Obviously, if a layer to be smoothed at an atomic scale would be damaged or rendered inoperative due to oxidation or an adverse chemical reaction resulting from bombardment by oxygen (O) or another gas, then an appropriate gas should be selected for smoothing that layer.

The predetermined acceleration voltage will be dependent on many factors including the desired energy (i.e. momentum) for the gas cluster ions 11, the mass of the gas cluster ions 11, the type of material for the selected layer, the thickness of the selected layer, and the initial surface roughness A_{I} of the interface surface 1, just to name a few. Preferably, the predetermined acceleration voltage is greater than about 2.0 kilovolts. The mass of the gas cluster ions will depend on the number of constituent atoms, molecules, or particles contained within each gas cluster ion 11 (mean cluster size). Each gas cluster ion 11 can have a mean cluster size that includes but is not limited to about 2,000 atoms per gas cluster ion 11.

In one embodiment of the present invention, gas cluster ion bombardment is performed only on those layers that precede the non-magnetic spacer layer 2 in the deposition order d_{O}. A gas cluster ion bombardment process includes selecting a layer that precedes the non-magnetic spacer layer 2 in the deposition order d_{O} for smoothing at an atomic scale, followed by smoothing an interface surface 1 of the selected layer by irradiating the interface surface 1 with the collimated beam of gas cluster ions as was described above in reference to FIGS. 13a through 14c, FIG. 15, FIG. 17, and FIGS. 18a through 18d. After the smoothing process, a next layer in the deposition order d_{O} can be deposited on the smoothed interface surface 1. Finally, the steps of selecting, smoothing, and depositing can be repeated until the next layer in the deposition order d_{O} is the non-magnetic spacer layer 2.

The selecting process includes determining whether or not a layer in the deposition order d_{O} will be smoothed at an atomic scale. If the layer is not to be smoothed at an atomic scale, then the next layer in the deposition order d_{O} is deposited on that layer and the selection process is repeated until the next layer in the deposition order d_{O} is the non-magnetic spacer layer 2.

The process of depositing the layers of the magnetoresistance memory cell 10 can be any microelectronic/semiconductor process that is suitable for fabricating the layers of a magnetoresistance memory cell. Those processes include but are not limited to chemical vapor deposition (CVD), ion beam deposition (IBD), sputtering including magnetron sputtering, physical vapor deposition (PVD) via plasma sputtering, and thermal or electron beam evaporation, for example. Sputtering is particularly useful for depositing the thin layers of a magnetoresistance memory cell.

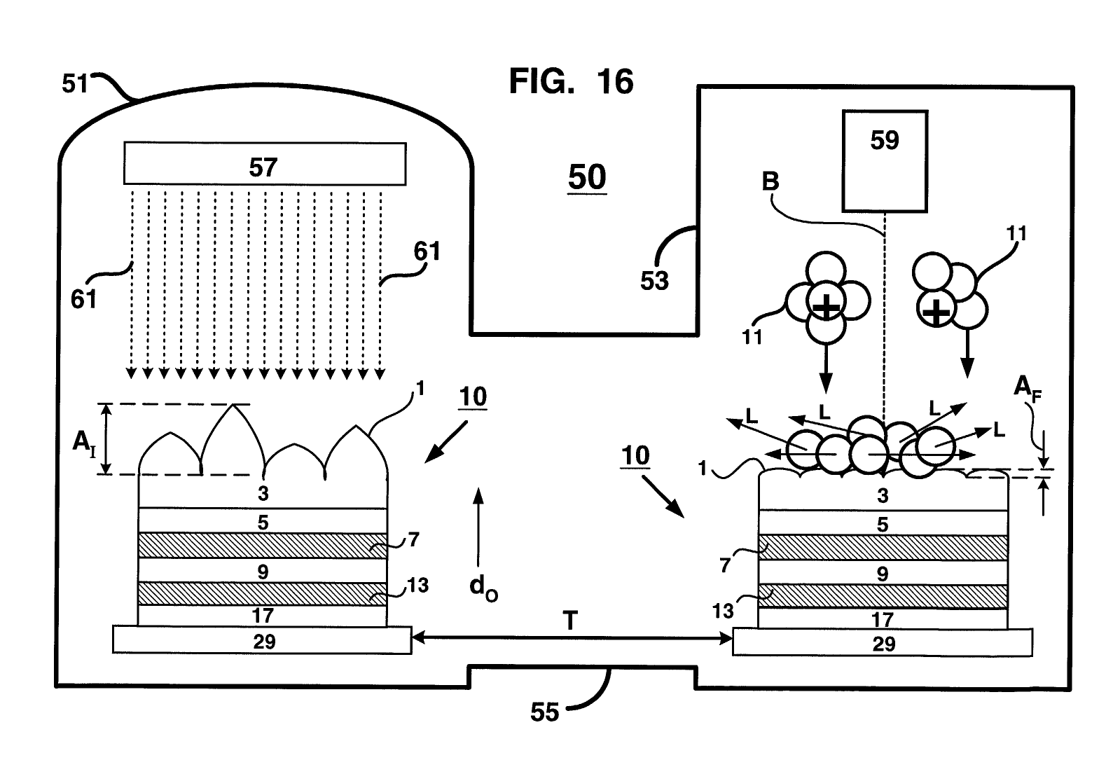

In another embodiment of the present invention, as illustrated in FIG. 16, a magnetoresistive memory cell 10 is fabricated with improved roughness uniformity and reduced roughness amplitude by insitu depositing and selective insitu smoothing a layer of the memory cell 10. Any layer deposited in a deposition order d_{O} may be selected for insitu smoothing. The magnetoresistive memory cell 10 includes a plurality of layers (six are shown) that are deposited on a substrate layer 17 in the deposition order d_{O} and the layers include a reference layer and a data layer that are separated by the non-magnetic spacer layer.

The method of fabricating the magnetoresistive memory cell 10 includes insitu depositing a layer in the deposition order d_{O} in a deposition chamber 51. In FIG. 16, a layer 3 in the deposition order d_{O} is being deposited in the deposition chamber 51. A deposition source 57 deposits material 61 onto a preceding layer 5 to form the layer 3. The deposition source 57 can include but is not limited to a CVD source or a sputtering source. After the layer 3 has been deposited a determination is made (e.g. the determination can be made in advance) as to whether or not the layer 3 is to be smoothed at an atomic scale using gas cluster ion bombardment as described above. In FIG. 16, the layer 3 is selected for smoothing at an atomic scale. An interface surface 1 of the layer 3 includes an initial surface roughness A_{I} and the layer 3 has been selected to smooth and reduce that initial surface roughness A_{I} to a final surface roughness A_{F} that has an improved roughness uniformity and reduced roughness amplitude as described above.

The selected layer 3 undergoes insitu smoothing in a smoothing chamber 53. The smoothing chamber 53 includes a gas cluster ion beam source 59 that generates a collimated beam of gas cluster ions 11 as was described above in reference to FIG. 15. In the smoothing chamber 53, the gas cluster ions 11 bombard and laterally sputter the interface surface 1 thereby removing one or more monolayer of material from the interface surface 1 so that the initial surface roughness A_{I} is reduced and homogenized to the final surface roughness A_{F} as described above. The substrate layer 17 may be connected with a chuck 29 or the like to facilitate handling of a wafer or substrate containing the magnetoresistive memory cell 10 during the insitu depositing and insitu smoothing processes.

In one embodiment of the present invention, the deposition chamber 51 and the smoothing chamber 53 are interconnected with each other. An interconnect structure 55, such as a load lock or the like, can be used to interconnect the deposition chamber 51 with the smoothing chamber 53. The interconnect structure can include a seal (not shown) that isolates the chambers (51, 53) from each other and prevents contamination from moving between the chambers (51, 53). The seal can also allow for differences in pressure between the chambers (51, 53). For instance, the deposition chamber 51 may be under a first partial vacuum and the smoothing chamber 53 may be under a second partial vacuum that is different than the first partial vacuum.

More than one deposition chamber 51 can be interconnected with the smoothing chamber 53. A plurality of deposition chambers 53 can be useful if more than one type of deposition process is required for depositing the layers of the memory cell 10. For example, if CVD and sputtering are required to deposit the layers, then a CVD deposition chamber can be interconnected with the smoothing chamber 53 via a first interconnect structure 55 and a sputtering deposition chamber can be interconnected with the smoothing chamber 53 via a second interconnect structure 55.

In another embodiment of the present invention, also illustrated in FIG. 16, a single integrated unit 50 includes the deposition chamber 51 and the smoothing chamber 53. In the single integrated unit 50, deposition of a layer of the memory cell 10 occurs in the deposition chamber 51. A deposited layer (e.g. layer 3) that is selected for insitu smoothing at an atomic scale is transported T from the deposition chamber 51 to the smoothing chamber 53 of the single integrated unit 50. Accordingly, the interconnect structure 55 as described above is not required. Therefore, exposure to microcontaminants or to an oxidizing or reactive atmosphere is eliminated. Another advantage is that the deposition chamber 51 and the smoothing chamber 53 can be supplied by a single vendor and the single integrated unit 50 can be custom tailored and optimized for fabricating magnetic memories. If required, the single integrated unit 50 can contain more than one deposition chamber as mentioned above (e.g. CVD and sputtering deposition chambers or separate sputtering chambers each having a different sputtering target).

Furthermore, in some instances it may be necessary to use more than one smoothing chamber 53. For example, some layers of the memory cell may require smoothing by a first type of gas cluster ion 11 and other layers may require smoothing by a second type of gas cluster ion 11. For instance, the first type of gas cluster ion 11 can be an inert gas and the second type of gas cluster ion 11 can be a reactive gas. Separate smoothing chambers 53 may be necessary to prevent contamination that can be caused by using different gases or to reduce downtime caused by re-configuring a single smoothing chamber 53 to smooth with a different gas. To that end, a plurality of smoothing chambers 53 can be used. The plurality of smoothing chambers 53 can be connected to one or more deposition chambers 51 via one or more interconnect structures 55 or the single integrated unit 50 can include a plurality of smoothing chambers 53 and one or more deposition chambers 51.

A layer selected for insitu smoothing in the determining step (i.e. layer 3 of FIG. 16) is transported T from the deposition chamber 51 to the smoothing chamber 53 for insitu smoothing. After the insitu smoothing is completed, the layer is transported T back to the deposition chamber 51 to deposit the next layer in the deposition order d_{O}. A robotic actuator, a conveyor, or other similar apparatus used in handling devices in microelectronic fabrication can be used to transport T the magnetoresistive memory cell 10 to and from the chambers (51, 53). If the chambers (51, 53) are interconnected using the interconnect structure 55, then the layer can be transported T via the interconnect structure 55. In contrast, if the single integrated unit 50 is used for deposition and smoothing, then there is no need for the interconnect structure 55 and the layer can be transported T between the chambers (51, 53) by a robotic actuator, a conveyor, or other similar apparatus, for example.

A major advantage of insitu deposition and insitu smoothing using gas cluster ion bombardment is that micro contamination that could result from moving a deposited layer from a separate deposition chamber to a separate smoothing chamber is reduced or completely eliminated by the insitu deposition and insitu smoothing method of the present invention. Furthermore, both chambers (51, 53) and the interconnect structure 55 can be maintained at a partial vacuum or can be filled with an inert atmosphere so that a layer that is deposited is not exposed to a reactive atmosphere. For instance, exposure to air may cause a deposited layer to form an oxide film due to an oxidation reaction.

The deposition chamber 51 can be any commercially available deposition machine used in microelectronic fabrication. The smoothing chamber can be a commercially available gas cluster ion processing system. Preferably, for all the embodiments described herein, the gas cluster ions 11 are generated by an ULTRA SMOOTHER™ Processing System such as the US50M ULTRA SMOOTHER™ made by the Epion™ Corporation, 37 Manning Road, Billerica, Mass. 01821. The US50M ULTRA SMOOTHER™ is particularly well suited to ultra-smooth surface processing of thin films of material like the interface surface (1, 1a) of a layer of material in the magnetoresistive memory cell 10 of the present invention. Other gas cluster ion sources can be used and the present invention is not limited to the ULTRA SMOOTHER™. For the embodiment of FIG. 16, the deposition chamber 51 can be a MESC compatible cluster tool that is interconnected with the US50M ULTRA SMOOTHER™.

The method of atomic scale smoothing of one or more layers of a memory cell as described herein is not limited to TMR and GMR memory cells. The method of the present invention is applicable to any magnetic memory cell constructed from stacked layers of material.

Although several embodiments of the present invention have been disclosed and illustrated, the invention is not limited to the specific forms or arrangements of parts so described and illustrated. The invention is only limited by the claims.

What is claimed is:

1. A method of fabricating a magnetoresistive memory cell including a plurality of layers deposited on a substrate layer in a deposition order wherein the layers include a reference layer and a data layer separated by a non-magnetic spacer layer, with improved roughness uniformity and reduced roughness amplitude, comprising:
smoothing at an atomic scale an interface surface of a selected layer of the memory cell by irradiating the interface surface with a collimated beam comprising a plurality of gas cluster ions that are accelerated along a beam path by a predetermined acceleration voltage,
the gas cluster ions bombard the interface surface and disintegrate upon impact therewith in a direction that is substantially lateral to the beam path,
the impact removing at least one monolayer of material from the interface surface wherein an initial surface roughness of the interface surface is reduced and homogenized to a final surface roughness.

2. The method as set forth in claim 1, wherein the selected layer precedes the non-magnetic spacer layer in the deposition order.

3. The method as set forth in claim 2, wherein the selected layer immediately precedes the non-magnetic spacer layer in the deposition order.

4. The method as set forth in claim 3, wherein the selected layer is a layer selected from the group consisting of a data layer and a reference layer.

5. The method as set forth in claim 1, wherein the gas cluster ions comprise a gas selected from the group consisting of argon, krypton, xenon, nitrogen, hydrogen, oxygen, helium, and a reactive gas.

6. The method as set forth in claim 1, wherein the predetermined acceleration voltage is greater than about 2.0 kilovolts.

7. The method as set forth in claim 1, wherein the initial surface roughness is in a range from about 5.0 angstroms to about 40.0 angstroms and the final surface roughness is in a range from about 1.0 angstrom to about 10.0 angstroms.

8. The method as set forth in claim 1, wherein the initial surface roughness is a first RMS surface roughness in a range from about 5.0 angstroms to about 40.0 angstroms and the final surface roughness is a second RMS surface roughness in a range from about 1.0 angstrom to about 10.0 angstroms.

9. The method as set forth in claim 1, wherein the selected layer is the non-magnetic spacer layer.

10. The method as set forth in claim 9, wherein the non-magnetic spacer layer is made from a material selected from the group consisting of dielectric material and a non-magnetic electrically conductive material.

11. The method as set forth in claim 1, wherein the selected layer is a layer selected from the group consisting of a ferromagnetic layer, a pinned layer, a pinning layer, a seed layer, a cap layer, a buffer layer, a substrate layer, and a current carrying layer.

12. The method as set forth in claim 1, wherein the selected layer is a layer of an antiferromagnet.

13. The method as set forth in claim 12, wherein the antiferromagnetic is selected from the group consisting of an artificial antiferromagnet, a synthetic antiferromagnet, and a synthetic ferrimagnet.

14. The method as set forth in claim 1, wherein the interface surface and the beam path are spatially oriented relative to each other so that the beam path intersects the interface surface with a spatial orientation selected from the group consisting of a substantially normal angle of incidence and an angle of incidence that is not normal to the interface surface.

15. A method of fabricating a magnetoresistive memory cell including a plurality of layers deposited on a substrate layer in a deposition order wherein the layers include a reference layer and a data layer separated by a non-magnetic spacer layer, with improved roughness uniformity and reduced roughness amplitude, comprising:
selecting a layer that precedes the non-magnetic spacer layer in the deposition order for smoothing at an atomic scale;
smoothing the selected layer by irradiating an interface surface thereof with a collimated beam comprising a plurality of gas cluster ions that are accelerated along a beam path by a predetermined acceleration voltage,
the gas cluster ions bombard the interface surface and disintegrate upon impact therewith in a direction that is substantially lateral to the beam path, the impact removing at least one monolayer of material from the interface surface wherein an initial surface roughness of the interface surface is reduced and homogenized to a final surface roughness;
depositing a next layer in the deposition order on the interface surface; and
repeating the selecting step, the smoothing step, and the depositing step until the next layer in the deposition order is the non-magnetic spacer layer.

16. The method as set forth in claim 15, wherein the initial surface roughness is in a range from about 5.0 angstroms to about 40.0 angstroms and the final surface roughness is in a range from about 1.0 angstrom to about 10.0 angstroms.

17. The method as set forth in claim 15, wherein the initial surface roughness is a first RMS surface roughness in a range from about 5.0 angstroms to about 40.0 angstroms and the final surface roughness is a second RMS surface roughness in a range from about 1.0 angstrom to about 10.0 angstroms.

18. The method as set forth in claim 15, wherein the gas cluster ions comprise a gas selected from the group consisting of argon, krypton, xenon, nitrogen, hydrogen, oxygen, helium, and a reactive gas.

19. The method as set forth in claim 15, wherein the predetermined acceleration voltage is greater than about 2.0 kilovolts.

20. The method as set forth in claim 15, wherein the interface surface and the beam path are spatially oriented relative to each other so that the beam path intersects the interface surface with a spatial orientation selected from the group consisting of a substantially normal angle of incidence and an angle of incidence that is not normal to the interface surface.

21. The method as set forth in claim 15, wherein the selected layer is a layer selected from the group consisting of a ferromagnetic layer, a pinned layer, a pinning layer, a seed layer, a cap layer, a buffer layer, a substrate layer, and a current carrying layer.

22. A method of fabricating a magnetoresistive memory cell including a plurality of layers deposited on a substrate layer in a deposition order wherein the layers include a reference layer and a data layer separated by a non-magnetic spacer layer, with improved roughness uniformity and reduced roughness amplitude by insitu depositing and selective insitu smoothing of one or more layers of the memory cell, comprising:
insitu depositing in a deposition chamber a layer of the memory cell;
determining if the layer is to be selected for smoothing at an atomic scale;
insitu smoothing the selected layer in a smoothing chamber by irradiating an interface surface thereof with a collimated beam comprising a plurality of gas cluster ions that are accelerated along a beam path by a predetermined acceleration voltage,
the gas cluster ions bombard the interface surface and disintegrate upon impact therewith in a direction that is substantially lateral to the beam path,
the impact removing at least one monolayer of material from the interface surface wherein an initial surface roughness of the interface surface is reduced and homogenized to a final surface roughness; and
repeating the insitu depositing step, the determining step, and the insitu smoothing step until there are no more layers to be deposited or smoothed.

23. The method as set forth in claim 22, wherein the deposition chamber and the smoothing chamber are interconnected with each other and further comprising:
insitu transporting the layer selected in the determining step to the smoothing chamber for insitu smoothing; and
insitu transporting the layer back to the deposition chamber after completing the insitu smoothing to deposit the next layer in the deposition order.

24. The method as set forth in claim 22, wherein the deposition chamber and the smoothing chamber are a single integrated unit and further comprising:
insitu transporting the layer selected in the determining step to the smoothing chamber for insitu smoothing; and
insitu transporting the layer back to the deposition chamber after completing the insitu smoothing to deposit the next layer in the deposition order.

25. The method as set forth in claim 22, wherein the initial surface roughness is in a range from about 5.0 angstroms to about 40.0 angstroms and the final surface roughness is in a range from about 1.0 angstrom to about 10.0 angstroms.

26. The method as set forth in claim 22, wherein the initial surface roughness is a first RMS surface roughness in a range from about 5.0 angstroms to about 40.0 angstroms and the final surface roughness is a second RMS surface roughness in a range from about 1.0 angstrom to about 10.0 angstroms.

27. The method as set forth in claim 22, wherein the gas cluster ions comprise a gas selected from the group consisting of argon, krypton, xenon, nitrogen, hydrogen, oxygen, helium, and a reactive gas.

28. The method as set forth in claim 22, wherein the predetermined acceleration voltage is greater than about 2.0 kilovolts.

29. The method as set forth in claim 22, wherein the interface surface and the beam path are spatially oriented relative to each other so that the beam path intersects the interface surface with a spatial orientation selected from the group consisting of a substantially normal angle of incidence and an angle of incidence that is not normal to the interface surface.

30. The method as set forth in claim 22, wherein the selected layer is a layer selected from the group consisting of a ferromagnetic layer, a pinned layer, a pinning layer, a seed layer, a cap layer, a buffer layer, a substrate layer, and a current carrying layer.
